(19) United States
(12) Patent Application Publication
(10) Pub. No.: US 2004/0044541 A1
(43) Pub. Date: Mar. 4, 2004

(54) Method of telemarketing supplier oversight

(75) Inventor: Grace E. Whatley, Midlothian, VA (US)

Correspondence Address: BAKER BOTTS L.L.P., 2001 ROSS AVENUE, SUITE 600, DALLAS, TX, 75201-2980, US

(73) Assignee: Capital One Financial Corporation

(21) Appl. No.: 10/291,143

(22) Filed: Nov. 7, 2002

Related U.S. Application Data
(60) Provisional application No. 60/407,467, filed on Aug. 30, 2002.

(51) Int. Cl. G06F 17/60

(52) U.S. Cl. 705/1; 705/10

(57) ABSTRACT

Telemarketing suppliers generate screens for telephone service representatives from provided scripts. By imposing certain expectations on those screens, the functionality of the screens and the data captured at those screens, the adherence to the scripts programmed on the screens may be improved, the quality of the captured data may be improved, and the time to encode and proof the implementation of the script on the screen may be substantially reduced.

### RELATED APPLICATION

This application claims the benefit of U.S. provisional application Serial No. 60/407,467, filed Aug. 30, 2002, entitled Method of Telemarketing Supplier Oversight.

### TECHNICAL FIELD OF THE INVENTION

The present invention relates generally telemarketing and, more specifically, to a method of overseeing telemarketing suppliers.

### BACKGROUND OF THE INVENTION

Organizations in need of telemarketing services often turn to telemarketing suppliers for such services. The telemarketing supplier is provided with a script which is programmed into a computer system to provide a series of screens that are presented, on a display, to a telephone service representative during a telephone solicitation. These scripts are typically programmed by the suppliers into their computer systems.

### SUMMARY OF THE INVENTION

In accordance with a particular embodiment of the present invention, a system for overseeing a telemarketing system includes a data storage unit operable to store information concerning telemarketing service providers. This information may include the proficiency of individual service providers at providing telemarketing service. The system also includes a program operable to solicit a potential telemarketing supplier, compare the supplier's telemarketing system to a set of base criteria which the program directs to the supplier during the solicitation process, and store the supplier compliance information in the data storage unit.

In accordance with another embodiment of the present invention, a method for overseeing a telemarketing system includes an entity in need of telemarketing services, a customer, sending a set of solicitation documents to a potential supplier and the supplier returning a set of screen prints to the customer based on the solicitation document requirements. According to this embodiment, the customer may then compare the supplier's screen prints to the production criteria established by the solicitation documents and provide feedback to the supplier concerning the supplier's performance in setting up the system for providing the customer with telemarketing services.

Certain technical advantages include decreased time to determine supplier compliance with a telemarketing customer's production requirements and increased accuracy of the information presented by telephone service representatives during a telemarketing call. Other technical advantages of these embodiments will be apparent to one skilled in the art from the following figures, descriptions and claims. Moreover, while specific advantages have been enumerated above, various embodiments may include all, some or none of the enumerated advantages.

### BRIEF DESCRIPTION OF THE DRAWINGS

For a more complete understanding of the present invention and its advantages, reference is now made to the following description, taken in conjunction with the accompanying drawing, in which:

FIG. 1 illustrates a prior art oversight method; and

FIG. 2 illustrates an exemplary telemarketing supplier oversight method according to and embodiment of the present invention.

FIG. 3 illustrates an exemplary telemarketing supplier oversight system according to and embodiment of the present invention.

### DETAILED DESCRIPTION OF THE PREFERRED EMBODIMENTS

Among other things, and according to certain embodiments, the present invention provides a method and system for overseeing a telemarketing system that substantially reduces the time and effort required by the trial-and-error approaches currently used to verify proper format and presentation of the telemarketing scripts.

Telemarketing suppliers typically have diverse types of programming schemes to program the scripts for the telephone service representatives. This makes it necessary to verify that the scripts are presented in a proper format to the telephone service representatives in a labor intensive, trial-and-error process. Although a great deal of time is spent programming and proofing a script, errors may still occur. These errors may include, but are not limited to, missing script pages, inappropriate solicitation data, and other errors. Because telemarketing is highly regulated by the government, some pre-programmed scripts are required by law. These laws often vary from jurisdiction to jurisdiction. Thus, for a nationwide or even continent-wide telemarketing solicitation, there may exist hundreds or even thousands of permutations of screens that will be shown to the telephone service representatives. Therefore, errors are often difficult to locate and recognize.

Another problem is that the data supplied to the telemarketing supplier may not be programmed correctly into their systems. This can result in data conversion errors such as a 14.9 annual percentage rate being presented to the telephone service representative as a 1.4 annual percentage rate. Similarly, data encoded by the representatives during a solicitation may be improperly encoded. Such problems can result in the loss of valuable data, the imposition of fines and a large investment in time to clean up the errors. Accordingly, there is a strong need in the art for an efficient method to oversee a telemarketing supplier to ensure that the telemarketing script is correct and accurate, which results in the capture of all appropriate data, and which is implemented in a time-efficient manner.

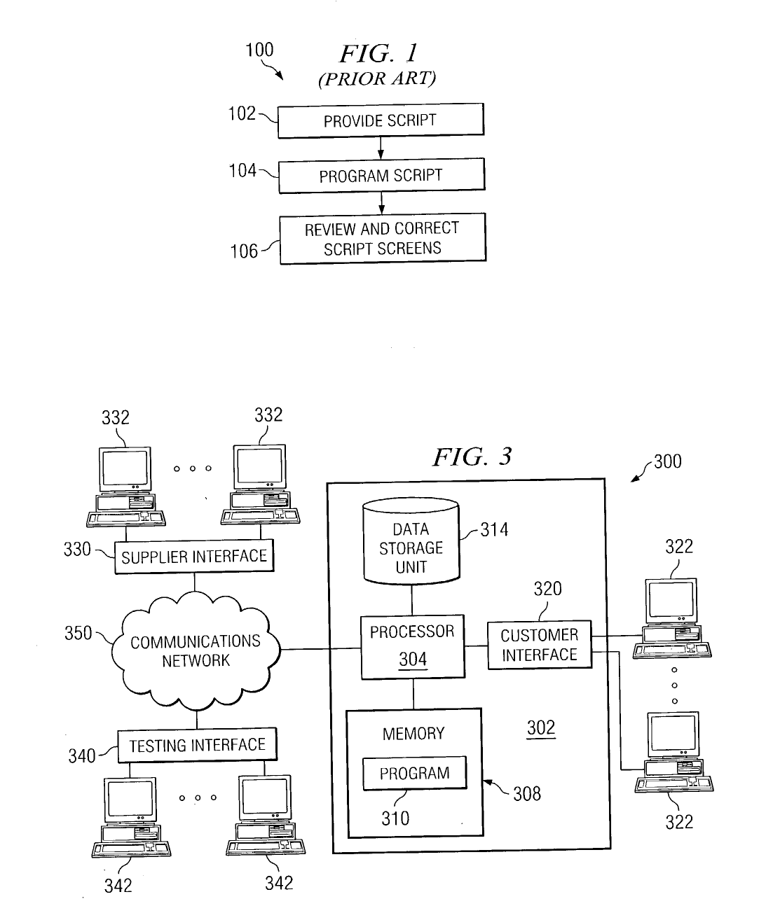

FIG. 1 illustrates a prior art oversight method. The prior art oversight method 100 includes the company in need of telemarketing service, a “customer”, providing a script 102 to a potential telemarketing service provider, a “supplier.” The script, which is the detailed information presented on a telemarketing screen during a telemarketing call, is then programmed in a script programming step 104 which is then followed by reviewing and correcting the screens in step 106. This method 100 requires the customer to spend considerable time to learn about each supplier's script encoding through trial and error. Similarly, problems that arise with the script or data captured during telemarketing are also corrected through trial and error. This method is haphazard and slow.

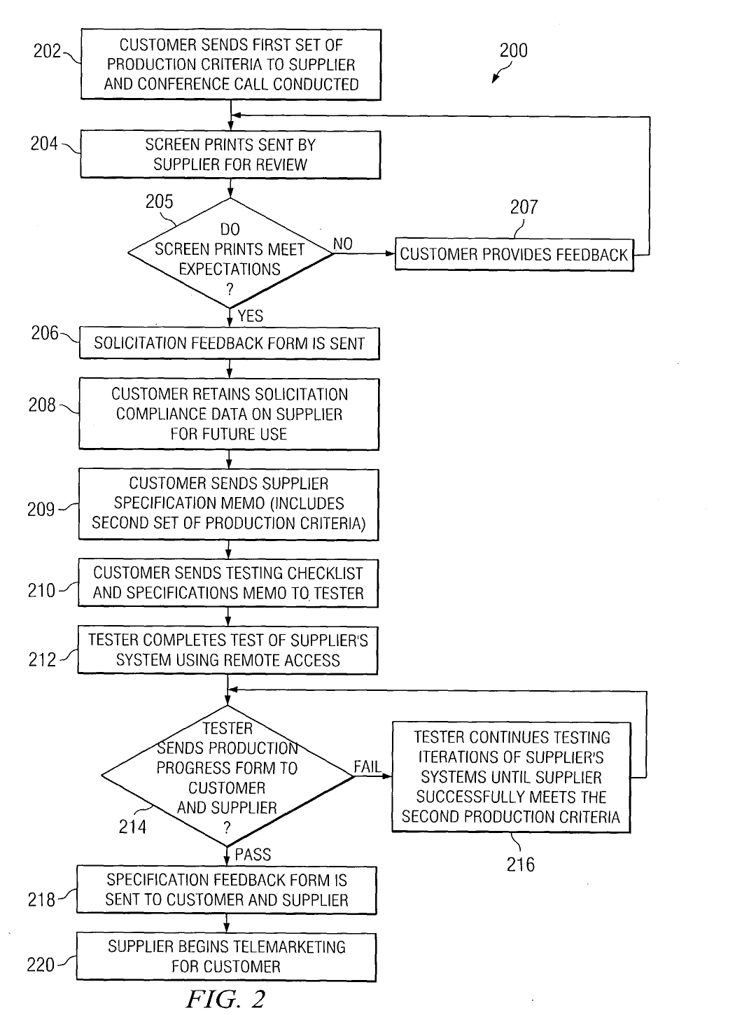

FIG. 2 illustrates an exemplary telemarketing supplier oversight method 200 in accordance with an embodiment of the present invention. Oversight method 200 begins with a customer providing solicitation set up documents to the supplier and conducting a conference call 202. The solicitation set up documents provide a first set of production criteria for the supplier's prospective telemarketing system and may include screen expectations, a testing checklist, a testing agreement, a most-common-errors list identifying the most common errors that affect the customer and which need to be corrected, and a programming-questions list which provides programming questions for the supplier to answer.

Preferably, the first set of production criteria contain at least the screen expectations, which describe in specific detail exactly what the screens are expected to look like for the telephone service representatives. “Screens” in this context may be defined as the appearance of the data on a computer monitor, terminal, or other suitable data display device during the telemarketing call. For example, one screen expectation may involve a date-of-birth field which should not allow invalid dates of birth such as invalid leap years, data including only one number (e.g., 22 22 2222), underage date of birth, and any entry of a letter (e.g., the letter “O” instead of the number “0” (zero), or a lower case letter L “l” instead of the number “1” (one). These guidelines may help to prevent problems which may otherwise require subsequent corrective measures.

The testing checklist may include all of the information verified during the step of reviewing the suppliers' screen prints, which may be hard-copy versions of the supplier's screens. Additionally, the may be requested to verify every item on the testing checklist so that the testing will proceed efficiently.

The testing agreement may be a signed statement which states the supplier has used the testing checklist in developing screens and in ensuring scripts are accurate. Additionally, the suppliers may also be required to agree to meet the customer's expectations during testing of the suppliers' systems. Each supplier may be held to this agreement if problems occur during testing. Thus, the agreement preferably promotes supplier compliance with the agreement and the more efficient development of a supplier telemarketing system that is satisfactory to the customer.

A most-common-errors list is provided to identify and prevent potential problems. This most-common-errors list identifies the most common errors encountered during development and implementation of a supplier's telemarketing system, and serious errors (such as violation of jurisdictional legal requirements for telemarketers), which which may be compiled from prior testing.

The programming questions-list provides questions for the supplier, the answers to which enable the customers and testers to quickly identify how a supplier programs its screens, learn how the screens are linked to each other, learn what changes may affect other parts of the script, and learn how the supplier typically addresses problems that may occur during development of the telemarketing system. This information provides an understanding of the encoding environment such that many of the problems of the trial-and-error approach are avoided. Once all of these documents are sent to the supplier, and still at step 202, a conference call may follow to discuss each document and answer any questions from the supplier. When the supplier's questions, if any, have been answered, the script may be programmed into the supplier's computer system.

Next, screen prints may be sent by the supplier for review by the customer in step 204. The screen prints reviewed in step 204 are preferably exact copies of the screens displayed by the supplier's telemarketing system, and are the supplier's attempt to comply with the standards established by the supplier according to the customer's first set of production criteria. In step 205, the customer may determine if the screen prints meets the screen expectations, and thus the first set of production criteria. This allows the customer to preview the screens before testing. If the screen prints do not meet the screen expectations, the customer provides feedback to the supplier in step 207, preferably via a conference call, email, or a formal solicitation feedback form so that the supplier may correct the programming of the screens. Step 204 is then repeated. The supplier providing screen prints for review and the customer providing feedback in step 207 may be continued until the screen prints have a passing iteration and meet the first set of production criteria provided by the customer in the solicitation setup documents.

Once the supplier meets the customer's first set of production criteria, the customer may send the supplier a solicitation feedback form in step 206 which preferably provides the supplier with information regarding how the customer grades or rates the performance of the supplier in its compliance with the first set of production criteria. Additionally, at step 208, the customer retains the results of the supplier's efficiency and/or a rating of the supplier's ability to comply with the first set of production criteria as provided in the solicitation setup documents for future use by the customer. Thus, in the present embodiment, a supplier may only have to achieve compliance with the first set of production criteria once in order for the customer to repeatedly use that supplier for telemarketing operations. As such, the suplier may become a “preliminarily qualified” supplier by meeting a certain efficiency or achieving a certain rating during a single instance of compliance or a predetermined number of instances of compliance with that customer's first set of production criteria.

Next, a specification memorandum is provided to the supplier in step 209 followed by a testing checklist in step 210. In an alternative embodiment, the process may start at step 209 when a supplier has an established relationship or has previously satisfied the customer's first set of production criteria to become a “preliminarily qualified” supplier. The specification memorandum outlines the specific script requirements of the customer's telemarketing plan that the supplier must incorporate into its screens.

Telephone conferences, electronic mail, or any other suitable means of conversing or correspondence may be used to review the specification memorandum and/or testing checklist, and to answer any questions from the supplier. The specification memorandum constitutes a second set of production criteria, and may include the scripts and other required information such as call plans and any legal updates for state, federal, or local laws, rules, ordinances, or regulations with which the supplier must comply for a particular telemarketing operation. Additionally, specific concerns may be outlined in the specification memorandum regarding any previous testing or telemarketing performed by the supplier for the customer. These concerns may include any continuing issues or recent mistakes. Also, any specific changes or complicated programming issues within the scripts may be outlined and any expectations on how these changes should be implemented may be included in the specification memorandum. The supplier will preferably return a signed testing agreement and testing checklist to the customer before testing begins.

Next, in step 212, testing is performed preferably by remote access. Any commercially available or other software that allows for remote viewing may be used, such as, for example, PC Anywhere™. Thus, the tester gains access to the supplier's telemarketing system to view the supplier's screens. The tester may gain this access through any suitable communications network, such as a dial-up modem, local area network (LAN), the Internet, or any other suitable method of accessing the supplier's system. The tester is able to view the supplier's screens, and is able to see exactly what is being displayed by the supplier's computer to a telephone service representative who is conducting a telemarketing call. This environment is referred as the testing environment and is preferably a mirror of the actual telemarketing environment. The tester may also uses the testing checklist to ensure everything required by the first and second sets of production criteria, as well as any additional requirements by the customer, have been thoroughly checked.

If any programming issues are discovered, testing may be immediately stopped until the error is fixed. This is where knowledge of the supplier's method of programming is valuable. The tester needs to know what effect any programming changes may have on the supplier's telemarketing system to ensure that the screens are completely corrected. If small errors are found, such as misspelled words, hardcoded verbiage left out, or duplicate words, the testing may continue and these corrections may be performed after the initial testing is completed.

Next, in step 214, a production progress form is returned to the supplier. The production progress form may provide the supplier with specific or general feedback for the preceding iteration. For example, if the supplier's screens contained script errors, if the tester detected programming errors relating to accessibility of particular screens that the telemarketing service representative accessed during a test, or the supplier failed to meet any of the second set of production criteria, the production progress form could identify these errors to the supplier in detail. Alternatively, the production progress form may provide overall performance data for the preceding test, to include the number of requirements of the second set of production criteria passed versus the number of requirements failed, etc. If the supplier fails the preceding test iteration, the testing is repeated in step 216 until the supplier completes a test successfully. After successfully completing step 216, the supplier receives a specification feedback form from the customer in step 218. The customer may also record additional information regarding the supplier for use internally or for use by the customer's supplier managers, or may simply retain a copy of the specification feedback form.

The specification feedback form may be used during testing to track errors, to differentiate errors that are attributable to the supplier and errors that are not the supplier's fault, and to track how long testing takes. After testing, the specification feedback form may be used to send feedback to the supplier for future telemarketing operations for the customer. This form may rate the supplier based upon testing performance and/or provides passing or failing scores for each iteration of testing. Every time the supplier fails, the supplier may be penalized an iteration. Preferably, the expectation is that the supplier passes in a single iteration and if any additional iterations are required, the supplier has not met the expectations. However, other criteria may also be used.

The tester uses the specification feedback form to evaluate the supplier. This feedback may include the number of testing iterations, any issues encountered during the telemarketing process, an indication of whether the supplier deliverables were on time, and the testing time per test cell. The test cell is the number of telemarketing service providers performing telemarketing operations during any given test. Thus one “test cell” could be comprised of one or an infinite number of telemarketing service representatives for any given test. The testing time per test cell is figured using the total time taken for testing (including all iterations) divided by the number of test cells at the supplier. In addition, the tester may give positive and negative feedback on testing, areas of opportunities for the supplier for the next solicitation/testing, and an overall assessment of the setup process.

After testing is completed for the solicitation and the supplier is approved by the customer, the customer gives the supplier permission to begin telemarketing operations. A better understanding of the programming process is gained through the use of this method which results in a more rapid pinpointing of errors.

The method 200 may include certain expectations for data fields. For example, data fields are preferably programmed such that invalid information will not be accepted during the telemarketing session. For example, invalid information includes, but is not limited to, dates with invalid leap-years, data input of only one number, underage dates-of-birth for a particular jurisdiction, look-alike characters such as the letter “l” instead of the number “1” or the letter “O” instead of the number “0”.

Another expectation is that supplier screens will have a certain predetermined appearance and certain predetermined functionality. For example, it is expected that certain screens will be readily available (e.g., one keystroke for DOS systems and one click for point-and-click systems) at any given time. It also expected that the screens will have a certain predetermined data arrangement. This allows the analysis to proceed at a faster pace because the reviewer sees the information they expect and are able to more rapidly locate errors and correct them. This also allows the telemarketing service representative to efficiently go to previous screens to edit or revise information without undue delay or difficulty.

FIG. 3 illustrates one embodiment of a telemarketing oversight system 300. Telemarketing oversight system 300 comprises a computer 302 containing a processor 304, a memory 308 storing an oversight program 310 and a data storage unit 314 for storing data used by program 310. Telemarketing oversight system 300 also comprises customer interface 320, supplier interface 330, tester interface 340 and a communications network 350. Processor 304 of computer 302 is coupled to memory 308, local data storage unit 314, customer interface 320 and communications network 350. Processor 304 is operable to execute the logic of program 310 and access data stored in data storage unit 314. Customer interface 320 may be coupled to terminals 322, or any other suitable means for accessing computer system 302 via customer interface 320. Communications network 350 is coupled to processor 304, and may include one or more computer buses, local area networks, a global computer network, and/or any other type of communications link such as wireline, optical, or wireless communication link.

Supplier interface 330 may include terminals 332 for input and output of data through the supplier interface, or any other means suitable for the transmission of data through supplier interface 330 and is operable to communicate with processor 304 through communications network 350. Tester interface 340 may include terminals 342 for input and output of data through the tester interface and communicates with processor 304 and supplier interface 330 via communications network 350.

In an exemplary embodiment, a customer accesses data storage unit 314 via customer interface 320 and processor 304 to select a prospective telemarketing supplier. A telemarketing supplier may be selected specifically by a customer, or a supplier may be selected by program 310 based on criteria selected by the customer through customer interface 320. Once a telemarketing supplier has been selected, program 310 may direct processor 304 to transmit solicitation set up documents to the supplier through communications network 350 to supplier interface 330. The solicitation set up documents preferably define a first set of production criteria, and may include screen expectations, a testing checklist, a testing agreement, a list of the most common errors that effect the customer and which need to be corrected, and a set of programming questions for the supplier to answer. In one embodiment, the first set of production criteria consist of at least screen expectations.

After receiving the first set of production criteria, the supplier develops and transmits a set of screen prints via supplier interface 330 in communications network 350 to processor 304. Program 310 then determines if the screen prints meet the first set of production criteria, which are pre-selected and resident in the program logic sequence. If the screen prints do not meet the first set of production criteria, program 310 generates a list of deficiencies in a solicitation feedback form and transmits these deficiencies to the supplier via processor 304, communications network 350 and supplier interface 330. The solicitation feedback form may provide the supplier with information regarding how the customer grades or rates the performance of the supplier in its compliance with the first set of production criteria The supplier continues to transmit screen prints through communications network 350 to processor 304 until program 310 determines that the supplier screen prints meet the first set of production criteria, and informs supplier via supplier interface 330 that the supplier screen prints meet the first set of production criteria set forth in the solicitation setup documents.

Upon receiving a screen print set that is satisfactory from a supplier, program 310 may establish that supplier as a “preliminarily-qualified” supplier and directs processor 304 to store the supplier's information in data storage unit 314 for future use. A preliminarily-qualified supplier preferably has met a predetermined standard which may be related to the performance of that supplier in compliance with the first set of production criteria. For example, a supplier may achieve preliminarily-qualified status upon submitting acceptable screen prints to a customer, or may be required to meet the first set of production criteria in a specified number of screen print submissions to the customer. The stored information may include a rating of the particular supplier in performing the set up steps necessary to become a telemarketing supplier for the customer, copies of accepted screen prints, a copy of the testing agreement, and/or any other information that the customer deems appropriate for selecting telemarketing suppliers in the future. Additionally, program 310 may direct processor 304 to send a solicitation feedback form containing the results of the solicitation process to the supplier for its records and future use.

After a customer has established at least one preliminarily qualified supplier in data storage unit 314, the customer may select a supplier to perform actual telemarketing services. At this stage, the customer accesses customer interface 320 to instruct processor 304 to execute program 310 to select a potential telemarketing service provider from the established list of preliminarily qualified suppliers in data storage unit 314. Program 310 may select the potential supplier based on specific criteria desired by a customer or at random, or in any other method acceptable to a customer.

Upon selecting a preliminarily qualified supplier, program 310 transmits a specification memorandum to the potential supplier followed by a testing checklist. The specification memorandum constitutes a second set of production criteria, and may include the scripts and other required information such as call plans, the type of telemarketing service requested, and any legal updates for state laws with which the supplier must comply. The specification memorandum may also include items of specific concern for the customer with regard to testing, recent telemarketing service provided by the telemarketing service provider, as well as any recent mistakes attributable to the supplier's service. After the supplier has complied with the specification memorandum requirements provided by the customer, the supplier notifies program 310 that it is prepared to undergo testing. This notification is transmitted through supplier interface 330 and communications network 350 to processor 304 which then informs program 310.

Upon receiving input from the supplier that the supplier is prepared to undergo testing, program 310 selects an appropriate testing entity, which may be a representative of the customer or any outside agency that is approved by the customer to conduct testing of telemarketing service providers. Once a tester has been selected, program 310 notifies the tester through processor 304 in communications network 350 to tester interface 340. Using tester interface 340 and communications network 350, the tester accesses the supplier's telemarketing system, preferably via remote access. Any commercially or other software that allows for remote viewing and access of the supplier's telemarketing system may be used. The tester is able to view the supplier's screens to see what is being displayed by the supplier's telemarketing system to a telephone service representative who is conducting the telemarketing call as well as what data the representative is entering based on the consumer's responses to the questions in the scripts which are displayed on the screen. This environment may be referred to as the testing environment, and preferably is a replica of the production environment that would be used during an actual telemarketing operation. Program 310 may monitor the testing performed through testing interface 340 to the supplier interface 330 via communications network 350 to determine if the supplier's system as programmed meets the second set of production criteria set forth by the customer in the specification memorandum.

After the tester has completed a first test of the supplier's telemarketing system, program 310 compiles any errors that occurred during the operation of the supplier's telemarketing system, determines whether a second test iteration is necessary, and provides a test report to the supplier via processor 304, communications network 350, and supplier interface 330 in the form of a production progress form. The production progress form may provide the supplier with specific or general feedback for the preceding If the first testing iteration of the supplier's telemarketing system is not successful, program 310 may instruct the supplier to correct any errors encountered via the production progress form. After the supplier has corrected any errors disclosed in the production progress form, the supplier transmits via supplier interface 330 in communications network 350 to the processor 304 that the errors have been corrected, and program 310 may direct tester to perform a second testing iteration. The system will continue to conduct testing iterations of the supplier's telemarketing system until program 310 is satisfied that the supplier has met the specification memorandum's second set of production criteria.

After supplier has completed a successful testing iteration, program 310 transmits via processor 304 in communications network 350 to supplier interface 330 that the supplier has completed its requirements for satisfying the second set of production criteria and is given permission to begin actual telemarketing operations. In addition, program 310 may transmit to supplier a specification feedback form which may point out generally or in detail any or all errors that occurred during any or all testing iterations, and may allow the supplier to streamline its process for future telemarketing requests from the customer. The tester uses the specification feedback form to evaluate the supplier. This feedback may include the number of testing iterations, any issues encountered during the telemarketing process, an indication of whether the supplier deliverables were on time, and the testing time per test cell. The test cell is the number of telemarketing service providers performing telemarketing operations during any given test. Thus one “test cell” could be comprised of one or an infinite number of telemarketing service representatives for any given test. The testing time per test cell is figured using the total time taken for testing (including all iterations) divided by the number of test cells at the supplier.

In addition, the tester may give positive and negative feedback on testing, areas of opportunities for the supplier for the next solicitation/testing, and an overall assessment of the setup process. Finally, program 310 preferably directs processor 304 to store all information related to the supplier in data storage unit 314 for future use.

Although the present invention has been described in several embodiments, a myriad of changes and modifications are suggested to and may be made by one skilled in the art, and it is intended that the present invention encompass such changes and modifications.

What is claimed is:

1. A method of telemarketing oversight comprising:
a customer sending a first set of production criteria to a potential telemarketing service supplier;
the customer receiving a set of screen prints from the supplier;
the customer comparing the screen prints to the first set of production criteria;
the customer providing feedback to the supplier based on a supplier's compliance with the first set of production criteria; and
storing information regarding the supplier's compliance with the first set of production criteria for future telemarketing operations.

2. The method of claim 1, wherein the first set of production criteria comprises screen expectations, wherein the screen expectations define the a customer's minimum acceptable standard for screens.

3. The method of claim 2, further comprising:
a testing checklist;
a testing agreement;
a most-common-errors list; and
a programming-questions list, wherein the most-common-errors list identifies the most common errors encountered during the development and implementation of a telemarketer's system, and wherein the programming-questions list identifies how the supplier programs its screens.

4. The method of claim 1 wherein the customer scores the supplier based on the supplier's level of compliance with the first set of production criteria.

5. The method of claim 1, wherein the supplier conducts a conference call with a customer to discuss any issues raised by the first set of production criteria.

6. The method of claim 1, wherein the screen prints are iteratively submitted by the supplier until the customer is satisfied with the supplier's level of compliance with the first set of production criteria.

7. The method of claim 6, further comprising sending a solicitation feedback form to the supplier after the supplier achieves satisfactory compliance with the first set of production criteria, and wherein the solicitation feedback form comprises information regarding the customer's evaluation of the supplier's compliance with the first set of production criteria through the most recent test iteration.

8. The method of claim 7, further comprising sending a second set of production criteria to the supplier, wherein the second set of production criteria comprises the specific script requirements for a specific telemarketing operation.

9. The method of claim 8, wherein the supplier conducts a conference call with the customer to discuss any issues associated with the second set of production criteria.

10. The method of claim 8, further comprising sending a testing checklist to a tester.

11. The method of claim 10, wherein the tester conducts a test of the supplier's telemarketing system.

12. The method of claim 8, further comprising the tester sending a production progress form to the customer and the supplier, and wherein the production progress form details the level of compliance by the supplier to any production criteria.

13. The method of claim 12, further comprising repeated tests of the supplier telemarketing system until the supplier complies with all production criteria.

14. The method of claim 13, further comprising sending a specification feedback form to a supplier after the supplier complies with all production criteria, and wherein the specification feedback form comprises a rating of the supplier performance.

15. A system for providing telemarketing supplier oversight, comprising:
a computer system; and
a supplier interface coupled through a communications network to the computer system, and wherein the computer system comprises:
a data storage unit comprising a database operable to store information regarding a plurality of telemarketing service suppliers;
a processor coupled to the data storage unit; and
a computer readable medium comprising a program operable, when executed on the processor, to:
transmit a first set of production criteria from a customer to a prospective telemarketing supplier;
receive screen prints from the supplier, the screen prints generated based on the first set of production criteria; and
compare the screen prints with the first set of production criteria to determine whether the supplier meets a predetermined level of compliance.

16. The system of claim 15, wherein the first set of production criteria comprises screen expectations, and wherein the screen expectations define a customer's requirement for the appearance of the supplier's screens.

17. The system of claim 16, further comprising:
a testing checklist;
a testing agreement;
a list of common errors affecting the consumer; and
a set of programming questions.

18. The system of claim 15, wherein the program is further operable to store information regarding a supplier in the data storage unit for future telemarketing by the customer.

19. The system of claim 15, wherein the program is further operable to generate a solicitation feedback form to transmit comparison results to a supplier, and wherein the solicitation feedback form comprises information regarding the customer's evaluation of the supplier's compliance with the first set of production criteria through the most recent test iteration.

20. The system of claim 15, wherein the program is further operable to select a supplier from a plurality of suppliers stored in the data storage unit.

21. The system of claim 20, wherein the program is further operable to transmit a second set of production criteria to the supplier through the supplier interface.

22. The system of claim 21, wherein the second set of production criteria comprises:
detailed scripts required for a specific telemarketing application;
call plans; and
any legal updates with which the supplier must comply.

23. The system of claim 22, further comprising a tester interface coupled to the computer system through the communications network, and wherein the data storage unit stores information on at least one tester for use in testing supplier telemarketing systems.

24. The system of claim 23, wherein the program is further operable to select a tester from the data storage unit to determine whether a telemarketing system of the selected supplier is in compliance with production criteria;
receive tester input regarding a test of the supplier's telemarketing system;
determine whether the supplier successfully passed the test of its telemarketing system;
inform the supplier that an acceptable test has been performed on the supplier's telemarketing system; and
store telemarketing supplier test information on the data storage unit.

25. The system of claim 24, wherein the tester conducts a test of the supplier's system.

26. The system of claim 25, further comprising a remote test of the supplier's system.

27. The system of claim 25, wherein the program is further operable to monitor the test of the supplier's telemarketing system through a communications network.

28. The system of claim 26, wherein the program is further operable to generate a specification feedback form, and wherein the specification feedback form is used to inform the supplier of the supplier's proficiency during a test of the supplier's system.

29. The system of claim 15, wherein the program is further operable to inform the supplier through a communications network that the supplier may begin telemarketing operations.
